(19) United States
(12) Patent Application Publication
(10) Pub. No.: US 2022/0144668 A1
(43) Pub. Date: May 12, 2022

(54) WATER TREATMENT DEVICE AND WATER TREATMENT METHOD

(71) Applicant: KURITA WATER INDUSTRIES LTD., Tokyo (JP)

(72) Inventor: Naoya KAWARABAYASHI, Tokyo (JP)

(73) Assignee: KURITA WATER INDUSTRIES LTD., Tokyo (JP)

(21) Appl. No.: 17/601,930

(22) PCT Filed: Mar. 13, 2020
(86) PCT No.: PCT/JP2020/010977

§ 371 Date: Oct. 7, 2021

(30) Foreign Application Priority Data
Aug. 8, 2019 (JP) 2019-146365

(51) Int. Cl. C02F 1/24

(52) U.S. Cl. CPC C02F 1/24; C02F 2209/11

(57) ABSTRACT

The water treatment device includes: a coagulation reaction tank into which the water to be treated is introduced; a coagulant supply unit that supplies the coagulant; a floatation separation tank that makes the agglomerates float on the upper layer of the treated water to perform solid-liquid separation; and a coagulant addition amount adjustment device which adjusts the addition amount of the coagulant from the coagulant supply unit and adds the coagulant to the coagulation reaction tank. The coagulant addition amount adjustment device includes: a detection part for detecting the turbidity of the treated water inside the floatation separation tank; and an adjustment part for adjusting, on the basis of the detection value of the detection part, the amount of the coagulant added to the water to be treated. A detection unit of the detection part is installed inside the floatation separation tank.

### BACKGROUND

### Technical Field

The present invention relates to a water treatment device and a water treatment method.

The application is based upon and claims the benefit of priority from the Japanese Patent Application No. 2019-146365, filed on Aug. 8, 2019, the content of which is incorporated herein by reference.

### Related Art

A space-saving coagulation pressurizing flotation device does not have an open-top coagulation reaction tank, and a coagulant is made to react by in-line chemical injection. Therefore, in the space-saving coagulation pressurizing flotation device, there is no optimum place for installing an optimum coagulation sensor probe (detection unit) for measuring the turbidity between flocs. Thus, conventionally, an optical turbidity meter is installed in a treated water tank to measure the turbidity of treated water, and the chemical injection control of an inorganic coagulant on water to be treated is performed according to the turbidity of the treated water (for example, see Patent literature 1).

### LITERATURE OF RELATED ART

### Patent Literature

Patent literature 1: Japanese Patent Laid-Open No. 2007-263856

### SUMMARY

### Problems to be Solved

In the device described in Patent literature 1, the residence time of the water to be treated and the treated water in the coagulation tank, the floatation separation tank, and the treated water tank is as long as 1 hour or more in total. Therefore, when the chemical injection control of the inorganic coagulant on the water to be treated is performed according to the turbidity of the treated water measured in the treated water tank, the delay time until the result of the chemical injection control can be detected is also 1 hour or more. Thus, it is difficult to perform automatic chemical injection control having good responsiveness in the device described in Patent literature 1.

The present invention has been made in view of the above circumstances, and an object of the present invention is to provide a water treatment device and a water treatment method capable of performing automatic chemical injection control having good responsiveness.

### Means to Solve Problems

In order to solve the above problems, the present invention adopts the following configuration.

[1] A water treatment device, in which a coagulant is added to water to be treated and agglomerates are separated so as to obtain treated water, including: a coagulation reaction tank into which the water to be treated is introduced; a coagulant supply unit that supplies the coagulant; a floatation separation tank that makes the agglomerates float on the upper layer of the treated water to perform solid-liquid separation; and a coagulant addition amount adjustment device which adjusts the addition amount of the coagulant from the coagulant supply unit and adds the coagulant to the coagulation reaction tank; wherein the coagulant addition amount adjustment device includes: a detection part for detecting the turbidity of the treated water inside the floatation separation tank; and an adjustment part for adjusting, on the basis of the detection value of the detection part, the amount of the coagulant added to the water to be treated; and a detection unit of the detection part is installed inside the floatation separation tank.
[2] The water treatment device according to [1], wherein the detection unit of the detection part is installed within a height of ⅓ of the depth of the treated water from an inner bottom surface of the floatation separation tank.
[3] A water treatment method, in which the water treatment device according to [1] or [2] is used to add a coagulant to water to be treated and separate agglomerates so as to obtain treated water, including: a step in which the coagulant is supplied to the water to be treated and the agglomerates are generated in the coagulation reaction tank; a step in which the agglomerates are made to float on the upper layer of the treated water and solid-liquid separation is performed inside the floatation separation tank; a step in which the turbidity of the treated water is detected inside the floatation separation tank; and a step in which the amount of the coagulant added to the water to be treated is adjusted on the basis of the detection value of the turbidity.
[4] The water treatment method according to [3], wherein the turbidity of the treated water is detected within a height of ⅓ of the depth of the treated water from an inner bottom surface of the floatation separation tank.

### Effect

According to the present invention, a water treatment device and a water treatment method capable of performing automatic chemical injection control having good responsiveness can be provided.

### BRIEF DESCRIPTION OF THE DRAWINGS

FIG. 1 is a schematic diagram showing a water treatment device according to one embodiment of the present invention.

FIG. 2 is a configuration diagram showing the schematic configuration of a coagulation monitoring device used in the water treatment device according to one embodiment of the present invention.

FIG. 3 is an enlarged view showing the configuration of a laser light irradiation unit and a scattered light receiving unit of the coagulation monitoring device shown in FIG. 2.

FIG. 4 is an enlarged view showing the configuration of a shielding member of the coagulation monitoring device shown in FIG. 2.

FIG. 5 is a diagram showing the result of CFD analysis of treated water inside a floatation separation tank in Experimental example 1.

FIG. 6 is a diagram showing the result of CFD analysis of the treated water inside the floatation separation tank in Experimental example 1.

FIG. 7 is a plan view of the water treatment device shown in FIG. 1.

### DESCRIPTION OF THE EMBODIMENTS

An embodiment of a water treatment device and a water treatment method of the present invention is described.

It should be noted that the embodiment is specifically described in order to make the gist of the invention understood better, and does not limit the present invention unless otherwise specified.

[Water Treatment Device]

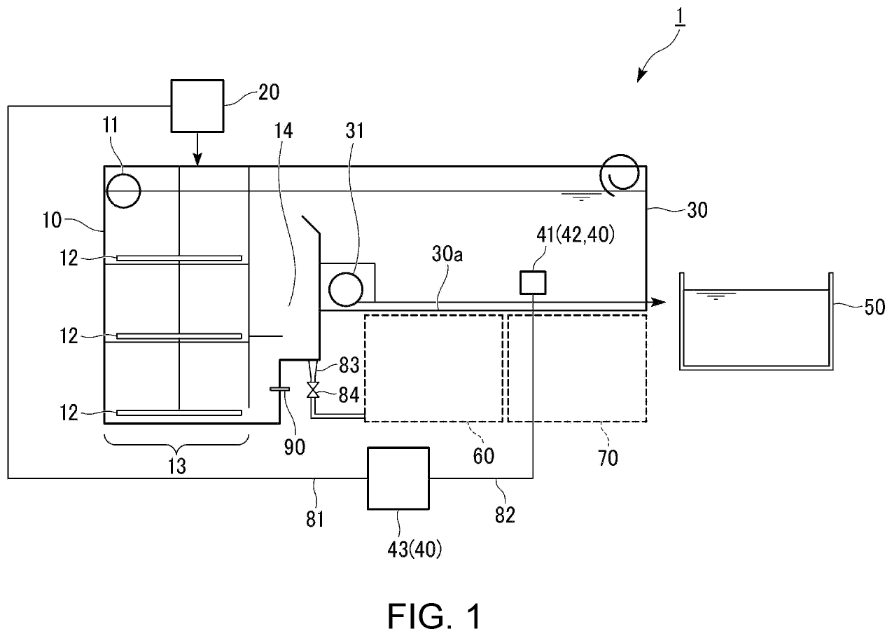

FIG. 1 is a schematic diagram showing a water treatment device according to one embodiment of the present invention.

As shown in FIG. 1, a water treatment device 1 of the embodiment includes a coagulation reaction tank 10, a coagulant supply unit 20, a floatation separation tank 30, and a coagulant addition amount adjustment device 40. In addition, the water treatment device 1 of the embodiment may include a treated water tank 50, a pressurized water manufacturing unit 60, and a control panel 70.

The coagulation reaction tank 10 is configured to coagulate suspended substances contained in raw water (water to be treated) introduced from a raw water introduction port 11. The coagulation reaction tank 10 includes a multi-stage reaction tank 13 having a plurality of spaces (three spaces in FIG. 1) which are partitioned via reverse osmosis membranes 12, and a mixing chamber 14.

The raw water may be tap water, well water, industrial water, or the like.

The multi-stage reaction tank 13 is configured to supply a coagulant to the water to be treated introduced from the raw water introduction port 11 and adjust the pH of the water to be treated by adding an alkaline agent such as liquid caustic soda or the like to the water to be treated.

The mixing chamber 14 is configured to mix a polymer solution with the water to be treated to which the coagulant is added in the multi-stage reaction tank 13. The polymer solution is supplied from a polymer solution supply unit 90 to the water to be treated introduced into the mixing chamber 14 through the multi-stage reaction tank 13. In addition, the mixing chamber 14 is connected to the pressurized water manufacturing unit 60 via an introduction pipe 83 and an electromagnetic valve 84.

The coagulant supply unit 20 is configured to supply the coagulant to the water to be treated introduced into the multi-stage reaction tank 13. The coagulant supply unit 20 is connected to the coagulant addition amount adjustment device 40 via a signal line 81.

The floatation separation tank 30 is configured to make the agglomerates which are coagulated by the coagulant float on the upper layer of the treated water to separate the agglomerates and the treated water into solid and liquid.

The floatation separation tank 30 has a treated water introduction port 31 that introduces the treated water (water after the coagulation treatment is performed) and the agglomerates obtained by mixing, inside the mixing chamber 14, the water to be treated to which the coagulant is added and the polymer solution.

The coagulant addition amount adjustment device 40 is configured to adjust the addition amount of the coagulant from the coagulant supply unit 20 and add the coagulant to the coagulation reaction tank 10.

The coagulant addition amount adjustment device 40 includes a detection part 41 for detecting the turbidity (coagulation state of micro colloid particles in the treated water) of the treated water inside the floatation separation tank 30, and an adjustment part 43 for adjusting, on the basis of the detection value of the detection part 41, the amount of the coagulant added to the water to be treated inside the mixing chamber 14.

A detection unit 42 of the detection part 41 is installed inside the floatation separation tank 30. In addition, the detection unit 42 is connected to the adjustment part 43 via a signal line 82.

The detection unit 42 of the detection part 41 is preferably installed within a height of ⅓ of the depth of the treated water inside the floatation separation tank 30 from an inner bottom surface 30a of the floatation separation tank 30.

The detection part 41 is not particularly limited as long as it is a transmission light type detection part. However, it is preferable that the detection part 41 irradiates laser light to the treated water, receives scattered light generated due to particles contained in the treated water, and detects the turbidity of the treated water.

As the detection part 41, for example, a coagulation monitoring device as described below is used.

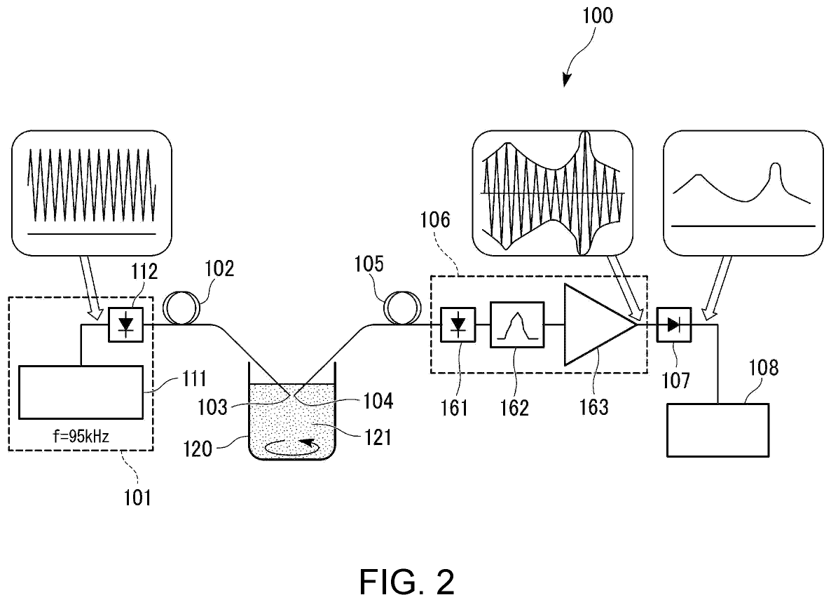

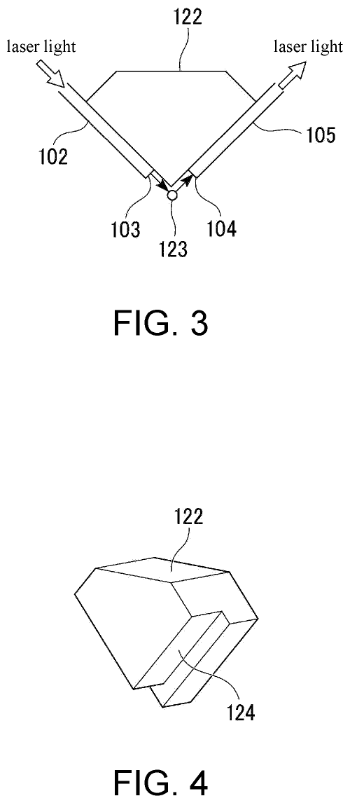

FIG. 2 is a configuration diagram showing the schematic configuration of the coagulation monitoring device used in the embodiment. FIG. 3 is an enlarged view showing the configuration of a laser light irradiation unit and a scattered light receiving unit of the coagulation monitoring device shown in FIG. 2. FIG. 4 is an enlarged view showing the configuration of a shielding member of the coagulation monitoring device shown in FIG. 2.

As shown in FIG. 2, a coagulation monitoring device 100 includes a laser oscillator 101, a first optical fiber 102, a laser light irradiation unit 103, a scattered light receiving unit 104, a second optical fiber 105, a photoelectric conversion circuit 106, a detection circuit 107, and a lowest value detection circuit 108.

In addition, in FIG. 2, reference numeral 120 denotes a floatation separation tank in which treated water 121 is stored, and corresponds to the floatation separation tank 30 shown in FIG. 1. The laser light irradiation unit 103 and the scattered light receiving unit 104 arranged at the bottom of a shielding member 122 shown in FIG. 3 are put into the treated water 121 inside the floatation separation tank 120. As shown in FIG. 3, the shielding member 122 shields the natural light from above from reaching a measurement region 123 between the laser light irradiation unit 103 and the scattered light receiving unit 104.

That is, as shown in FIG. 4, the shielding member 122 is a pentagonal prism having a bottom surface protruding downward and groove portions 124 formed on two protruding side surfaces. As shown in FIG. 3, the first optical fiber 102 and the second optical fiber 105 are fixed to the groove portion 124. The laser light irradiation unit 103 which is one end of the first optical fiber 102 and the scattered light receiving unit 104 which is one end of the second optical fiber 105 are arranged symmetrically (line-symmetrically) on the left and right in FIG. 3. Furthermore, central lines of the laser light irradiation unit 103 of the first optical fiber 102 and the scattered light receiving unit 104 of the second optical fiber 105 preferably intersect with each other at 90 degrees.

In addition, generally, the intensity of the laser light oscillated from the laser oscillator 101 is preferably modulated in order to be distinguished from natural light. In order to return the scattered light intensity received by the photoelectric conversion circuit 106 to the original electric signal, the intensity of the laser light oscillated from the laser oscillator 101 is preferably modulated by about 70 kHz to 150 kHz. Thus, in the configuration of the embodiment, the laser oscillator 101 consists of a function generator 111 and a laser diode 112. The laser oscillator 101 emits, from the laser diode 112 to one end of the first optical fiber 102, laser light that is amplitude-modulated (AM) with an electric signal generated from the function generator 111 and having a predetermined frequency, for example, 95 kHz. The laser light is emitted into the water to be treated from the other end of the optical fiber 102 that is the laser light irradiation unit 103 via the first optical fiber 102. It should be noted that the laser oscillator 101 is not limited to the one consisting of the function generator 111 and the laser diode 112, and for example, a light emitting diode or the like can also be used.

Micro colloid particles (uncoagulated colloid particles) exist in the treated water 121. The laser light irradiated from the laser light irradiation unit 103 to the micro colloid particles in the treated water 121 is scattered and becomes scattered light, and is incident to the second optical fiber 105 from one end of the second optical fiber 105 which is the scattered light receiving unit 104. In the embodiment, the measurement region 123 of the micro colloids is a region in which a region irradiated by the laser light emitted from the laser light irradiation unit 103 overlaps a region where the scattered light receiving unit 104 can receive the scattered light. The scattered light receiving unit 104 receives scattered light scattered in the direction of 90 degrees (central line of the second optical fiber 105) from the measurement region 123.

The photoelectric conversion circuit 106 consists of a photodetector 161, a bandpass filter 162, and an amplifier 163.

The photodetector 161 is connected to the other end of the second optical fiber 105 and converts an optical signal of scattered light incident to the second optical fiber 105 into an electric signal. The bandpass filter 162 extracts the signal of the modulation frequency component from the electric signal obtained by converting the optical signal by the photodetector 161 in order to make a distinction from natural light.

The amplifier 163 amplifies the signal of the modulation frequency component extracted by the bandpass filter 162 and outputs the signal to the detection circuit 107.

It should be noted that the photoelectric conversion circuit 106 is not limited to the one having the above configuration as long as it converts an optical signal into an electric signal. As the photoelectric conversion circuit 106, for example, a photodiode may be used instead of the photodetector, and a low-pass filter may be used instead of the bandpass filter.

The signal of the modulation frequency component is AM-detected by the detection circuit 107 in order to measure the change in the scattered light intensity, and the signal after the detection is output to the lowest value detection circuit 108. Moreover, the signal output by the detection circuit 107 is subjected to signal processing equivalent to that of the signal passing through a low-pass filter. Thus, by appropriately selecting the cutoff frequency of the bandpass filter 162, the detection circuit 107 can detect the signal as a signal of the output waveform of the direct current component in which the fluctuation of the cutoff frequency is removed, and output the signal to the lowest value detection circuit 108. In this way, by performing AM detection on the optical signal, among the optical signals detected by the photodetector 161, which has been subjected to extraction of the modulation frequency component by the bandpass filter 162 and amplification by the amplifier 163, the change in light intensity along with the scattering of the micro colloid particles can be measured as the change in signal intensity.

The lowest value detection circuit 108 detects the signal intensity having the lowest value from the signal of the direct current component input from the detection circuit 107. When described by the signal waveform output from the amplifier 163, the detection of the lowest value is to measure a constricted portion of the waveform. A portion other than the constricted portion shows a situation when coagulated colloid particles and uncoagulated micro colloids exist in the measurement region 123. The constricted portion shows a situation when the coagulated colloid particles leave the measurement region. Thus, by detecting the lowest value of the signal intensity by the lowest value detection circuit 108, the scattered light intensity when only the micro colloid particles (uncoagulated colloid particles) exist, that is, the number of the micro colloid particles can be measured. Besides, the reduction of the lowest value indicates that the number of the micro colloid particles in the measurement region is reduced. In addition, the increase of the lowest value indicates that the number of the micro colloid particles is increased.

In addition, in the coagulation monitoring device 100, there is no need to separately arrange a special measurement unit, and the laser light irradiation unit 103 and the scattered light receiving unit 104 which are attached to the shielding member 122 can be put into the floatation separation tank 120 to measure the scattered light. Therefore, the coagulation monitoring device 100 can have a simple device configuration. Furthermore, the coagulation monitoring device 100 can be a throw-in type monitoring device because the device configuration is simple and lightweight and miniaturization are achieved.

The treated water tank 50 is configured to recover the treated water obtained by solid-liquid separation inside the floatation separation tank 30.

The pressurized water manufacturing unit 60 is configured to manufacture the pressurized water supplied into the mixing chamber 12. By supplying the pressurized water manufactured by the pressurized water manufacturing unit 60 into the mixing chamber 12, the water to be treated and the coagulant are mixed inside the mixing chamber 12.

The control panel 70 is configured to control the electric power supplied to each portion (device) constituting the water treatment device 1.

In the water treatment device 1 of the embodiment, the coagulant addition amount adjustment device 40 includes the detection part 41 for detecting the turbidity of the treated water inside the floatation separation tank 30, and the adjustment part 43 for adjusting, on the basis of the detection value of the detection part 41, the amount of the coagulant added to the water to be treated. The detection unit 42 of the detection part 41 is installed inside the floatation separation tank 30. Therefore, according to the water treatment device 1 of the embodiment, on the basis of the detection value of the turbidity of the treated water inside the floatation separation tank 30, the amount of the coagulant added to the water to be treated inside the mixing chamber 14 is adjusted by the adjustment part 43. Thus, by the coagulant addition amount adjustment device 40, the delay time until the result of controlling the addition amount of the coagulant can be detected can be shortened. Accordingly, automatic chemical injection control having good responsiveness can be performed. In addition, the addition amount of the coagulant can be reduced.

In addition, when the detection unit 42 of the detection part 41 is installed within a height of ⅓ of the depth of the treated water inside the floatation separation tank 30 from the inner bottom surface 30a of the floatation separation tank 30, micro air in the treated water is released, and the turbidity between the agglomerates can be measured more accurately.

[Water Treatment Method]

In the water treatment method of the embodiment, the water treatment device of the embodiment is used to add the coagulant to the water to be treated and separate the agglomerates so as to obtain the treated water. The water treatment method of the embodiment includes: a step in which the coagulant is supplied to the water to be treated and the agglomerates are generated in the coagulation reaction tank 10; a step in which the agglomerates are made to float on the upper layer of the treated water and solid-liquid separation is performed inside the floatation separation tank 30; a step in which the turbidity of the treated water is detected inside the floatation separation tank 30; and a step in which the amount of the coagulant added to the water to be treated is adjusted on the basis of the detection value of the turbidity of the treated water inside the floatation separation tank 30.

With reference to FIGS. 1 to 4, the water treatment method of the embodiment is described.

The coagulant is supplied to the water to be treated supplied to the multi-stage reaction tank 13 of the coagulation reaction tank 10 (a coagulant supply step).

After the coagulant is added to the water to be treated in the multi-stage reaction tank 13, the polymer solution is supplied from the polymer solution supply unit 90 to the water to be treated introduced into the mixing chamber 14. In this state, the pressurized water manufactured by the pressurized water manufacturing unit 60 is supplied into the mixing chamber 14 via the introduction pipe 83 and the electromagnetic valve 84, and the water to be treated to which the coagulant is added and the polymer solution are mixed inside the mixing chamber 14. Accordingly, inside the mixing chamber 14, the suspended substances contained in the water to be treated are coagulated and aggregates are generated (an aggregate generation step).

The treated water and the agglomerates obtained inside the mixing chamber 14 are introduced into the floatation separation tank 30, and inside the floatation separation tank 30, the agglomerates are made to float on the upper layer of the treated water, and the agglomerates and the treated water are separated into solid and liquid (a solid-liquid separation step).

While the solid-liquid separation step is performed, the turbidity of the treated water (coagulation state of the micro colloid particles in the treated water) is detected by the detection unit 42 of the detection part 41 installed inside the floatation separation tank 30 (a detection step).

As a method for detecting the turbidity of the treated water, for example, a method is preferable in which laser light is irradiated to the treated water, scattered light generated due to the particles contained in the treated water is received, and the turbidity of the treated water is detected.

As the detection step, for example, a method using the coagulation monitoring device shown in FIG. 2 may be used.

Specifically, the principle of measuring the coagulation state using the agglomeration monitoring device 100 is as follows.

Inside the floatation separation tank 120, the coagulation treatment is promoted by stirring the treated water 121. When the micro colloid particles flow into and out of the measurement region 123 along with the stirring, the scattered light generated due to the micro colloid particles fluctuates. The period of fluctuation of the scattered light can be estimated by considering the measurement region 123 as a particle and assuming the number of collisions with the micro colloid particles. That is, when the measurement region 123 is assumed as and approximated to a sphere having a diameter R and the micro colloid particles are assumed as and approximated to spheres having a diameter r, a collision cross-sectional area Q0 in this case is expressed by Formula (1) described below.

$$Q 0 = {π ( R + r )}^{2} \qquad ( 1 )$$

In addition, when the density of the micro colloid particles is set as N and the relative velocity of the particles with respect to the measurement region 123 is set as v, the number of times v of the micro colloid particles flowing into the measurement region 123 per unit time is expressed by Formula (2) described below.

$$v = NQ 0 v \qquad ( 2 )$$

Similarly, because the same fluctuation also occurs when the micro colloid particles leave the measurement region 123, the period of the value obtained by differentiating the scattered light intensity is twice the number of times. Besides, when it is assumed that the scattered light intensity is proportional to the nth power of the particle size of the micro colloid particles, and multiple scattering is ignored, fluctuation A of the scattered light intensity along with the inflow and outflow of one micro colloid particle is expressed by Formula (3) described below.

$$A = A 0 {r}^{n} \qquad ( 3 )$$

Note that A0 is a constant that depends on the measurement system and is calibrated using a standard sample.

Here, because the micro colloid particles before coagulation have a small diameter r and a great particle density N, minute fluctuation in the scattered light generated due to the micro colloid particles occurs in a short period. Thus, by detecting the modulation frequency component by the detection circuit 107, the output waveform is subjected to signal processing equivalent to that in a case of passing through a low-pass filter as described above. Therefore, by appropriately selecting the cutoff frequency of the bandpass filter 162, the signal can be detected as the signal of the direct current component in which the fluctuation is removed.

On the other hand, in the case of the coagulated colloids (coagulation colloids), the fluctuation of the scattered light during the inflow to and the outflow from the measurement region 123 is great, and the average period of fluctuation of the scattered light becomes long. Thus, when the product of the density of the coagulation colloids and the volume of the measurement region is smaller than 1, the lowest value of the output waveform after detection corresponds to the scattered light of the colloids that are not coagulated (uncoagulated colloids). Thus, by connecting the lowest value detection circuit 108 to the rear stage of the detection circuit 107, the scattered light generated due to the coagulation colloids and the scattered light generated due to the uncoagulated colloids in the treated water 121 are distinguished. Accordingly, it is possible to extract only the scattered light generated due to the uncoagulated colloids so as to detect the coagulation state of the colloids, and the coagulation state of the colloids can be appropriately grasped.

In addition, the turbidity of the treated water is preferably detected by the detection unit 42 that is installed within a height of ⅓ of the depth of the treated water inside the floatation separation tank 30 from the inner bottom surface 30a of the floatation separation tank 30.

In addition, on the basis of the detection value of the turbidity of the treated water inside the floatation separation tank 30, the amount of the coagulant added to the water to be treated inside the mixing chamber 14 is adjusted by the adjustment part 43 (a coagulant addition amount adjustment step).

The water treatment method of the embodiment includes: the detection step in which the turbidity of the treated water is detected by the detection unit 42 of the detection part 41 installed inside the floatation separation tank 30; and the coagulant addition amount adjustment step in which the amount of the coagulant added to the water to be treated inside the mixing chamber 14 is adjusted by the adjustment part 43 on the basis of the detection value of the turbidity of the treated water inside the floatation separation tank 30. Therefore, according to the water treatment method of the embodiment, the amount of the coagulant added to the water to be treated is adjusted by the coagulant addition amount adjustment step on the basis of the detection value of the turbidity of the treated water inside the floatation separation tank 30. Thus, the delay time until the result of controlling the addition amount of the coagulant can be detected can be shortened by the coagulant addition amount adjustment step. Accordingly, automatic chemical injection control having good responsiveness can be performed. In addition, the addition amount of the coagulant can be reduced.

In addition, when the turbidity of the treated water is detected within a height of ⅓ of the depth of the treated water inside the floatation separation tank 30 from the inner bottom surface 30a of the floatation separation tank 30, the micro air in the treated water is released, and the turbidity between the agglomerates can be measured more accurately.

### EXAMPLE

Hereinafter, the present invention is further specifically described by an example and a comparative example, but the present invention is not limited to the following examples.

### Experimental Example 1

In the water treatment device 1 shown in FIG. 1, computational fluid dynamics (CFD) analysis was performed on the treated water inside the floatation separation tank 30.

As for the CFD analysis method, the CFD analysis software CFX 5.7 manufactured by Ansys company is used to define the analysis conditions (inflow, outflow, wall surface, and fluid) and execute the calculation.

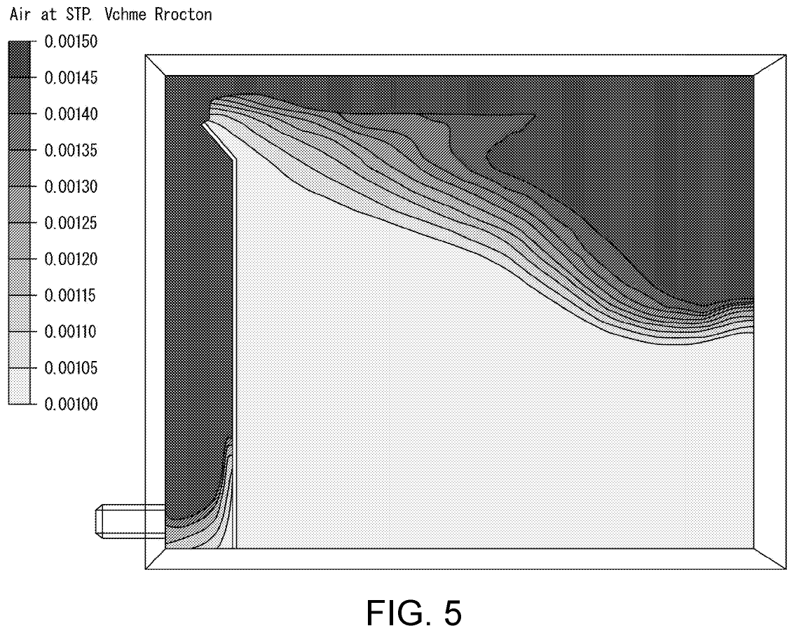

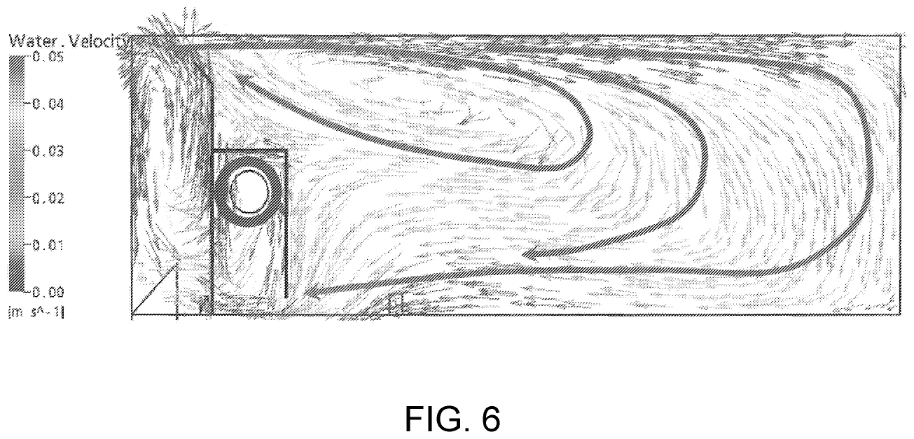

The results are shown in FIGS. 5 and 6.

From the results of FIGS. 5 and 6, it was confirmed that in the upper portion of the floatation separation tank 30, the floating agglomerates covered the surface, but the flow velocity of the treated water was high and a large amount of micro air existed below the agglomerates. On the other hand, it was presumed that at the bottom of the floatation separation tank 30, the flow velocity of the treated water was small, and micro air did not exist due to the floatation.

### Experimental Example 2

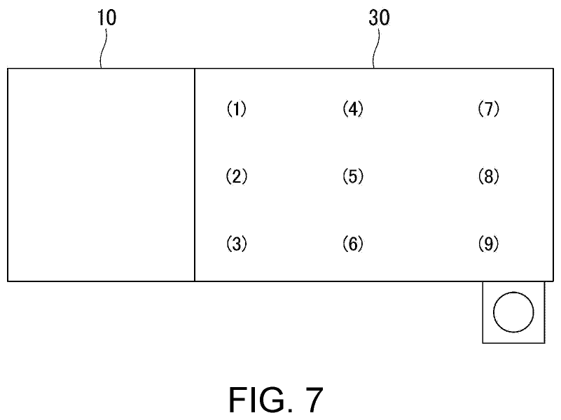

FIG. 7 is a plan view of the water treatment device 1 shown in FIG. 1.

As shown in FIG. 7, in a plan view of the floatation separation tank 30, the detection units 42 of the detection part 41 were disposed in positions (1) to (9). In addition, in the positions (1) to (9), the detection units 42 were also disposed in the lower, middle, and upper stages along the depth direction of the treated water inside the floatation separation tank 30. The detection unit 42 in the lower stage was disposed in a position within a height of ⅓ of the depth of the treated water inside the floatation separation tank 30 from the inner bottom surface 30a of the floatation separation tank 30. The detection unit 42 in the middle stage was disposed in a position exceeding the height of ⅓ of the depth of the treated water inside the floatation separation tank 30 and within a height of ⅔ of the depth from the inner bottom surface 30a of the floatation separation tank 30. The detection unit 42 in the upper stage was disposed in a position exceeding ⅔ of the depth of the treated water inside the floatation separation tank 30 and within a height of 3/3 of the depth from the inner bottom surface 30a of the floatation separation tank 30.

The turbidity of the treated water inside the floatation separation tank 30 was detected by the detection units 42 which were respectively disposed in position.

Table 1 shows the detection results of the turbidity of the treated water when the wastewater from the MH20Q mineral oil manufacturing plant is used as the water to be treated. In addition, Table 2 shows the detection results of the turbidity of the treated water when the wastewater from the MH05Q industrial waste factory is used as the water to be treated.

TABLE 1

| Turbidity | | | | | | | | | |
|---|---|---|---|---|---|---|---|---|---|
| NTU | (1) | (2) | (3) | (4) | (5) | (6) | (7) | (8) | (9) |
| Upper | 52.0 | 52.0 | 43.4 | 11.4 | 10.8 | 12.1 | 10.4 | 11.0 | 10.6 |
| stage | | | | | | | | | |
| Middle | 48.9 | 18.4 | 45.0 | 10.8 | 10.8 | 11.7 | 10.4 | 11.0 | 10.6 |
| stage | | | | | | | | | |
| Lower | 1.0 | 0.8 | 0.8 | 0.7 | 1.2 | 0.6 | 0.6 | 1.0 | 0.8 |
| stage | | | | | | | | | |

TABLE 2

| Turbidity | | | | | | | | | |
|---|---|---|---|---|---|---|---|---|---|
| NTU | (1) | (2) | (3) | (4) | (5) | (6) | (7) | (8) | (9) |
| Upper | 83.8 | 13.2 | 110.6 | 12.2 | 12.0 | 12.2 | 7.0 | 7.0 | 7.4 |
| stage | | | | | | | | | |
| Middle | 102.3 | 8.1 | 95.7 | 12.2 | 12.0 | 12.2 | 7.0 | 7.0 | 7.0 |
| stage | | | | | | | | | |
| Lower | 2.0 | 2.5 | 2.6 | 2.6 | 2.0 | 2.2 | 2.0 | 2.0 | 2.0 |
| stage | | | | | | | | | |

From the results in Tables 1 and 2, it was judged that the lower stage of the floatation separation tank 30 was in a position where the micro air was released and the turbidity between the agglomerates could be normally measured.

### Example

Water treatment was performed under the conditions described below using the water treatment device shown in FIG. 1.

Wastewater to be treated: chemical manufacture wastewater (before biological treatment)

Data collection period: 1 month

Treated water SS target value: 30 (mg/L) or less

The results are shown in Table 3.

### Comparative Example

Except that the detection unit of the detection part was disposed inside the treated water tank, water treatment was performed under the conditions described below using the same device as the water treatment device shown in FIG. 1.

Wastewater to be treated: chemical manufacture wastewater (before biological treatment)

Data collection period: 1 month

Treated water SS target value: 30 (mg/L) or less

The results are shown in Table 3.

TABLE 3

| | | | | Average | Average |
|---|---|---|---|---|---|
| | | Average | Average | addition | addition |
| | | value | value | ratio | ratio |
| | Water | of raw | of treated | of inorganic | of 25% |
| | discharge | water SS | water SS | coagulant | NaOH |
| | [m³/month] | [mg/L] | [mg/L] | [mg/L] | [mg/L] |
| Example | 8934 | 604 | 21.4 | 2642 | 700 |
| Comparative | 9502 | 727 | 12.9 | 3369 | 1067 |
| example | | | | | |

From the results in Table 3, it was confirmed that in the example, the addition amount of the inorganic coagulant could be reduced by about 20% as compared with the comparative example.

### REFERENCE SIGNS LIST

1 water treatment device
10 coagulation reaction tank
20 coagulant supply unit
30 floatation separation tank
40 coagulant addition amount adjustment device
41 detection part
42 detection unit
43 adjustment part
50 treated water tank

1. A water treatment device, in which a coagulant is added to water to be treated and agglomerates are separated so as to obtain treated water, comprising:
a coagulation reaction tank into which the water to be treated is introduced; a coagulant supply unit that supplies the coagulant; a floatation separation tank that makes the agglomerates float on the upper layer of the treated water to perform solid-liquid separation; and a coagulant addition amount adjustment device which adjusts the addition amount of the coagulant from the coagulant supply unit and adds the coagulant to the coagulation reaction tank; wherein
the coagulant addition amount adjustment device comprises: a detection part for detecting a turbidity of the treated water inside the floatation separation tank; and an adjustment part for adjusting, on the basis of the detection value of the detection part, the amount of the coagulant added to the water to be treated; and
a detection unit of the detection part is installed inside the floatation separation tank.

2. The water treatment device according to claim 1, wherein
the detection unit of the detection part is installed within a height of ⅓ of the depth of the treated water from an inner bottom surface of the floatation separation tank.

3. A water treatment method, in which the water treatment device according to claim 1 is used to add a coagulant to water to be treated and separate agglomerates so as to obtain treated water, comprising:
a step in which the coagulant is supplied to the water to be treated and the agglomerates are generated in the coagulation reaction tank;
a step in which the agglomerates are made to float on the upper layer of the treated water and solid-liquid separation is performed inside the floatation separation tank;
a step in which a turbidity of the treated water is detected inside the floatation separation tank; and
a step in which the amount of the coagulant added to the water to be treated is adjusted on the basis of the detection value of the turbidity.

4. The water treatment method according to claim 3, wherein
the turbidity of the treated water is detected within a height of ⅓ of the depth of the treated water from an inner bottom surface of the floatation separation tank.

5. A water treatment method, in which the water treatment device according to claim 2 is used to add a coagulant to water to be treated and separate agglomerates so as to obtain treated water, comprising:
a step in which the coagulant is supplied to the water to be treated and the agglomerates are generated in the coagulation reaction tank;
a step in which the agglomerates are made to float on the upper layer of the treated water and solid-liquid separation is performed inside the floatation separation tank;
a step in which a turbidity of the treated water is detected inside the floatation separation tank; and
a step in which the amount of the coagulant added to the water to be treated is adjusted on the basis of the detection value of the turbidity.

6. The water treatment method according to claim 5, wherein
the turbidity of the treated water is detected within a height of ⅓ of the depth of the treated water from an inner bottom surface of the floatation separation tank.
